(19) United States
(12) Patent Application Publication
(10) Pub. No.: US 2013/0189898 A1
(43) Pub. Date: Jul. 25, 2013

(54) COMBINATION PILLOW, BLANKET, AND STUFFED TOY

(71) Applicant: Lisa Abbott, Bunch, OK (US)

(72) Inventor: Lisa Abbott, Bunch, OK (US)

(21) Appl. No.: 13/355,967

(22) Filed: Jan. 23, 2012

(51) Int. Cl. A63H 3/02; B31B 1/26; A47G 9/02

(52) U.S. Cl. 446/73; 5/485; 493/405

(57) ABSTRACT

A combination pillow, blanket, and stuffed toy comprising a blanket with a pocket attached thereto, such that the blanket may be folded and the pocket may be turned inside out. The folded blanket is then located inside the pocket, forming a pillow. The pillow may then be converted into a stuffed toy by attaching a strap connected to one side of the pillow to the other side of the pillow, causing the pillow to fold downward and form a stuffed toy body.

### CROSS REFERENCE

Not Applicable

### BACKGROUND OF THE INVENTION

1. Field of the Invention

This invention relates generally to a combination pillow, blanket, and stuffed toy, and more particularly, but not by way of limitation, to a stuffed toy that unfolds into a pillow, which then unfolds into a blanket.

2. Description of the Related Art

Combination pillows and stuffed toys are a popular product, particularly among children. It is desirable to provide a combination pillow and stuffed toy that also incorporates a blanket.

### SUMMARY OF THE INVENTION

In general, in a first aspect, the invention relates to a combination pillow, blanket, and stuffed toy comprising: a blanket with a first end and a second end opposite the first end, where the first end has an edge; and a pocket attached to the blanket adjacent the first end, where the pocket has an open edge and an edge opposite the open edge, where the edge opposite the open edge is adjacent the edge of the first end, such that the blanket may be folded and the pocket may be turned inside out such that the folded blanket is located inside the pocket. The pocket may have a first edge and a second edge opposite the first edge, and the open edge and the edge opposite the open edge may both extend between the first edge and the second edge. The pocket may be connected to the blanket at least along the first edge and the second edge.

The combination pillow, blanket, and stuffed toy may further comprise: a strap with a first end and a second end, where the strap is attached at its first end to the pocket at the first edge of the pocket such that the strap is outside the pocket when the blanket is inside the pocket; and an attachment device for attaching the second end of the strap to the second edge of the pocket, such that the first edge of the pocket and the second edge of the pocket are held relatively closer to each other such that the pocket enclosing the blanket forms a stuffed toy body. The attachment device may be hook and loop fastener, and the hook and loop fastener may comprise: a patch of hook material on the second end of the strap; a patch of loop material on the pillow adjacent the second edge; and a flap attached to the strap adjacent the hook material such that the flap is capable of covering the hook material when not in use.

The combination pillow, blanket, and stuffed toy may further comprise a stuffed toy head. A patch of hook material may be attached to the stuffed toy head; a patch of loop material corresponding to the patch of hook material on the stuffed toy may be attached to the pocket such that the patch is outside the pocket when the blanket is inside the pocket, such that the stuffed toy head may be removably attached to the pocket enclosing the blanket; and a patch of loop material corresponding to the patch of hook material on the stuffed toy may be attached to the pocket such that the patch is outside the pocket when the blanket is outside the pocket, such that the stuffed toy head may be removably attached to the pocket to make the blanket appear to have a head. The stuffed toy head may have at least one flap attached to the stuffed toy head adjacent the patch of hook material such that the at least one flap is capable of covering the hook material when not in use. Alternately, the stuffed toy head may be non-removably attached to the pocket such that the stuffed toy head is outside the pocket when the blanket is inside the pocket. The pocket may have decorations such that the pocket resembles a head, where such decorations are on the outside of the pocket when the blanket is outside the pocket.

The combination pillow, blanket, and stuffed toy may further comprise one or more feet, paws, claws, hooves, fins, hands, wheels, or tails attached to the pocket such that the feet, paws, claws, hooves, fins, hands, wheels, or tails are outside the pocket when the blanket is inside the pocket. The combination pillow, blanket, and stuffed toy may further comprise one or more feet, paws, claws, hooves, hands, fins, wheels, or tails attached to the blanket. The blanket may have at least one corner, with a pocket attached to the at least one corner of the blanket.

The edge opposite the open edge of the pocket may comprise an attached portion and at least one finger hole, where the attached portion is attached to the blanket and where the at least one finger hole is not attached to the blanket. In use, a user may convert the combination pillow, blanket, and stuffed toy from a blanket to a pillow by; placing the blanket with the pocket facing downward; folding the blanket such that the entire blanket is on top of the pocket; placing a user's hands within the pocket; grasping the blanket through the at least one finger hole; and turning the pocket inside out, such that the folded blanket is located inside the pocket. The step of turning the pocket inside out may comprise quickly snapping the combination pillow, blanket, and stuffed animal while grasping the blanket through the at least one finger hole.

The user may then convert the combination pillow, blanket, and stuffed toy from a pillow to a stuffed toy by extending the strap underneath the pocket and attaching the strap to the second edge of the pocket such that the first edge of the pocket and the second edge of the pocket are held relatively closer to each other such that the pocket enclosing the blanket forms a stuffed toy body. If the head is removable, the user may then attach the removable stuffed toy head to the pocket. The process may be reversed to convert the stuffed toy to a pillow, and then to convert the pillow to a blanket.

### BRIEF DESCRIPTION OF THE DRAWINGS

FIG. 1 is a perspective view of a combination pillow, blanket, and stuffed toy in a stuffed toy configuration;

FIG. 2 is a perspective view of the combination pillow, blanket, and stuffed toy in a pillow configuration;

FIG. 3 is a perspective view of the combination pillow, blanket, and stuffed toy in a blanket configuration;

FIG. 4 is a perspective view of the top of the combination pillow, blanket, and stuffed toy in the blanket configuration with the head removed, indicating turning the blanket over;

FIG. 5 is a perspective view of the bottom of the combination pillow, blanket, and stuffed toy in the blanket configuration with the head removed;

FIG. 6 is a perspective view of the bottom of the combination pillow, blanket, and stuffed toy in the blanket configuration, indicating folding the blanket lengthwise in thirds;

FIG. 7 is a perspective view of the combination pillow, blanket, and stuffed toy in the blanket configuration, folded lengthwise in thirds;

FIG. 8 is a perspective view of the combination pillow, blanket, and stuffed toy in the blanket configuration, folded lengthwise in thirds, indicating folding the blanket in fourths;

FIG. 9 is a perspective view of the combination pillow, blanket, and stuffed toy in the blanket configuration, folded and ready to convert into a pillow, indicating turning the folded blanket over;

FIG. 10 a perspective view of the combination pillow, blanket, and stuffed toy in the blanket configuration, folded and ready to convert into a pillow, indicating hand placement for conversion into a pillow;

FIG. 11 is a perspective view of the combination pillow, blanket, and stuffed toy in the blanket configuration, folded and ready to convert into a pillow, indication the flipping motion used to convert the blanket into a pillow;

FIG. 12 is a perspective view of the combination pillow, blanket, and stuffed toy in the pillow configuration, indicating attaching the strap to convert the pillow into a stuffed toy;

FIG. 13 is a back view of the head of the combination pillow, blanket, and stuffed toy;

FIG. 14 is a perspective view of the combination pillow, blanket, and stuffed toy in the stuffed toy configuration, indicating attaching the head thereto;

FIG. 15 is a top view of an alternative embodiment of the combination pillow, blanket, and stuffed toy in the blanket configuration, with an animal head-shaped pocket; and

FIG. 16 is a bottom view of an alternative embodiment of the combination pillow, blanket, and stuffed toy in the blanket configuration.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

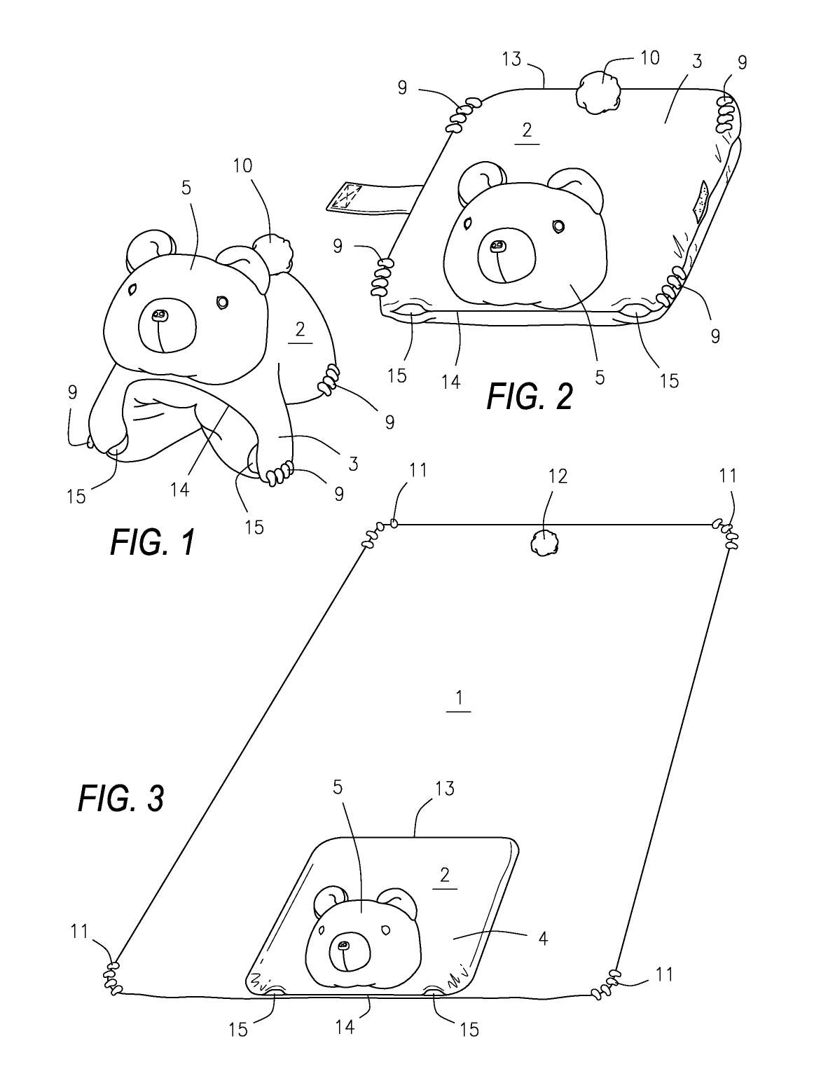

In general, in a first aspect, the invention relates to a combination pillow, blanket, and stuffed toy, as seen in FIG. 1 in a stuffed toy configuration, in FIG. 2 in a pillow configuration, and in FIG. 3 in a blanket configuration. The combination pillow, blanket, and stuffed toy comprises a blanket 1 with an attached pocket 2. The pocket 2 is capable of being turned inside out, such that it has a first side 3 and a second side 4, where the first side 3 is the outside of the pocket 2 when the second side 4 is the inside of the pocket 2 and the first side 3 is the inside of the pocket 2 when the second side 4 is the outside of the pocket 2. The first side 3 is the outside of the pocket 2 when the combination pillow, blanket, and stuffed toy is in the stuffed toy configuration or the pillow configuration, and the second side 4 is the outside of the pocket 2 when the combination pillow, blanket, and stuffed toy is in the blanket configuration. When in either the stuffed toy configuration or the pillow configuration, the blanket 1 is located inside the pocket 2, providing padding to the stuffed toy or pillow.

A decorative head 5 may be either removably or non-removably attached to the pocket 2. If the head 5 is removably attached to the pocket 2, it may be attached via hook and loop fastener. Specifically, a patch of hook material 6 may be located on the back of the head 5, as shown in FIG. 13. A patch of loop material 7 may be located on the first side 3 of the pocket 2, while a second patch of loop material 8 may be located on the second side 4 of the pocket 2, such that the head 5 may attach to either the first side 3 or the second side 4 of the pocket 2, depending on which side is the outside of the pocket 2 in a given configuration. Other decorative elements may include paws and/or claws 9 and/or a tail 10 located on the first side 3 of the pocket 2 such that they are visible when the combination pillow, blanket, and stuffed toy is in the stuffed toy or pillow configuration; and/or paws and/or claws 11 and/or a tail 12 located on the blanket 1 such that they are visible when the combination pillow, blanket, and stuffed toy is in the blanket configuration. While the drawings show a bear motif, it should be understood that any variety of designs may be utilized, including animals, people, objects, and characters.

The pocket 2 may have an open edge 13, which may be located along the back of the stuffed toy when in stuffed toy or pillow configuration. The edge 14 opposite the open edge 13 may be located along the front of the stuffed toy, and along one edge of the blanket 1. The edge 14 may be generally closed, but may have two open finger holes 15, allowing a user to reach from the inside of the pocket 2 to the outside through the finger holes 15.

The blanket 1 may be longer than it is wide, and the pocket 2 may be located adjacent to and centered along one of the short sides. The blanket 1 may be generally three times as wide as the width of the pocket 2, and generally four times as long as the depth of the pocket 2.

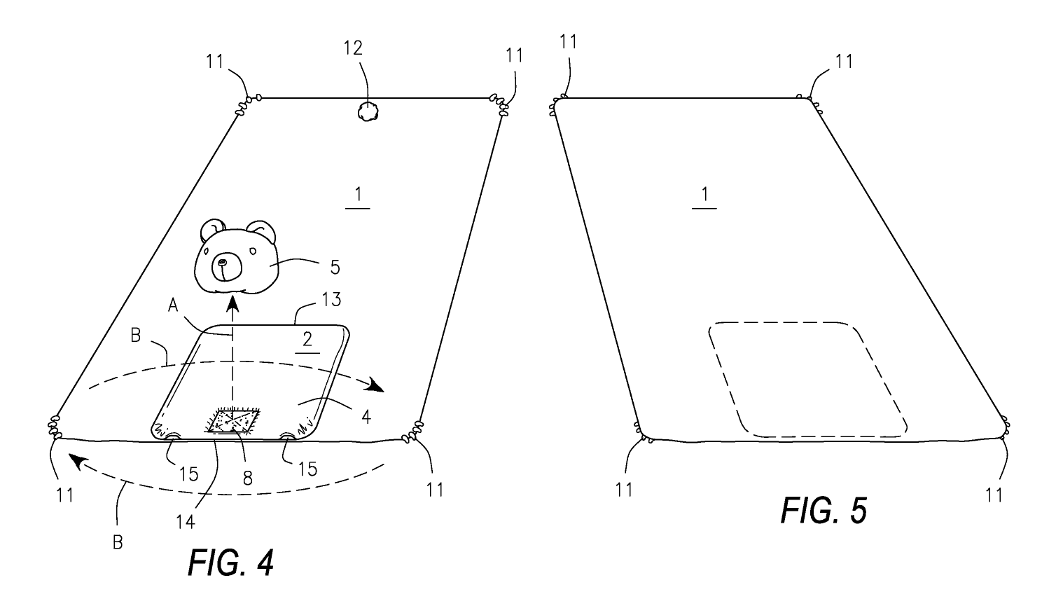

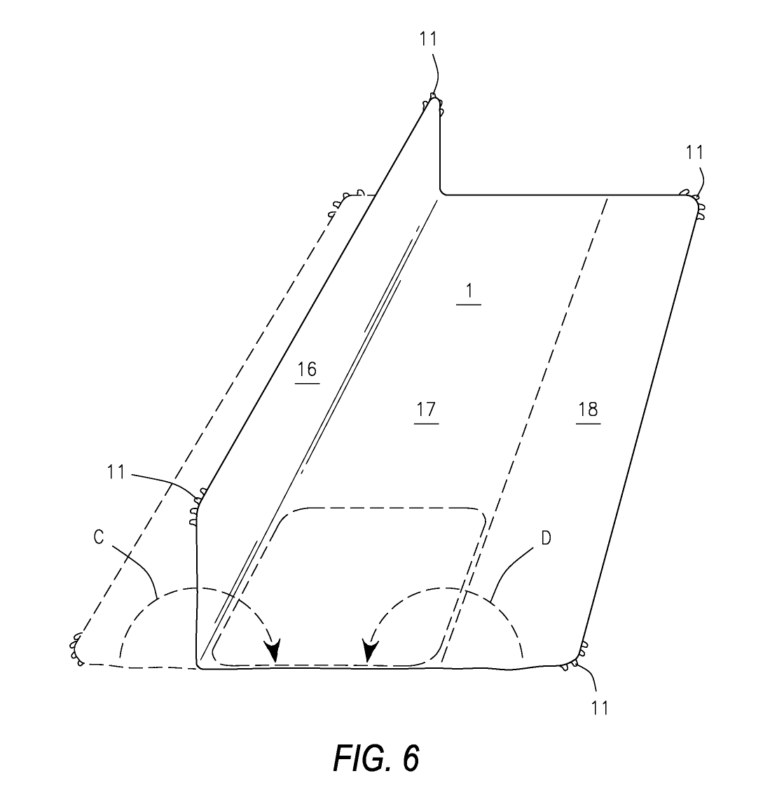

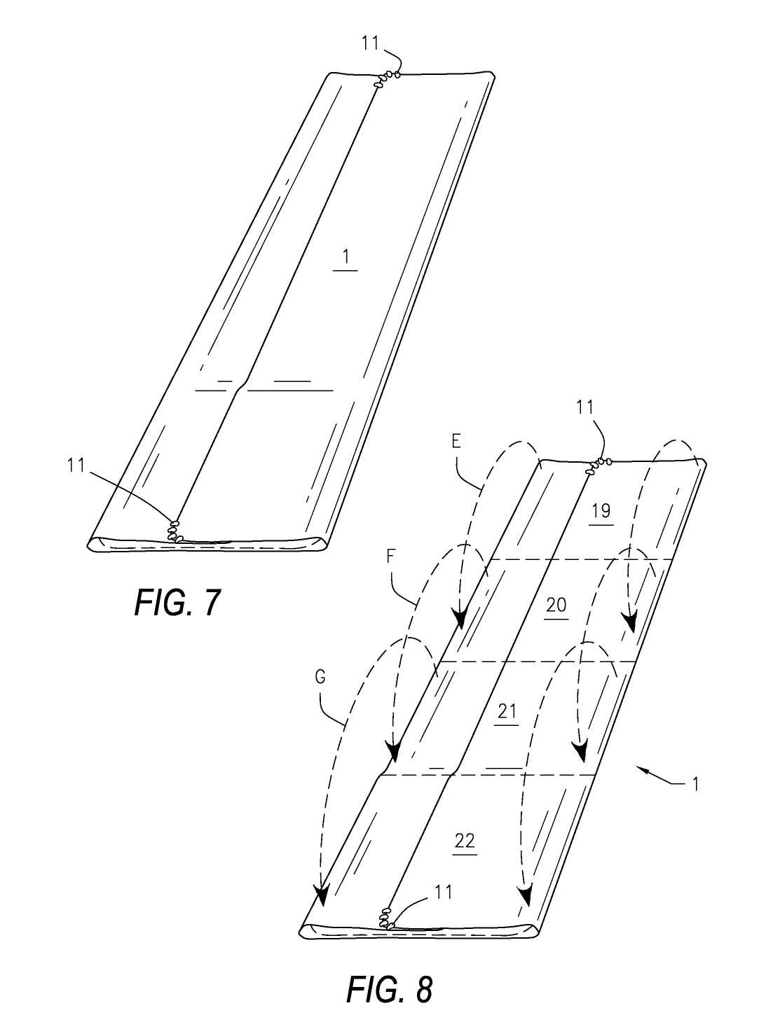

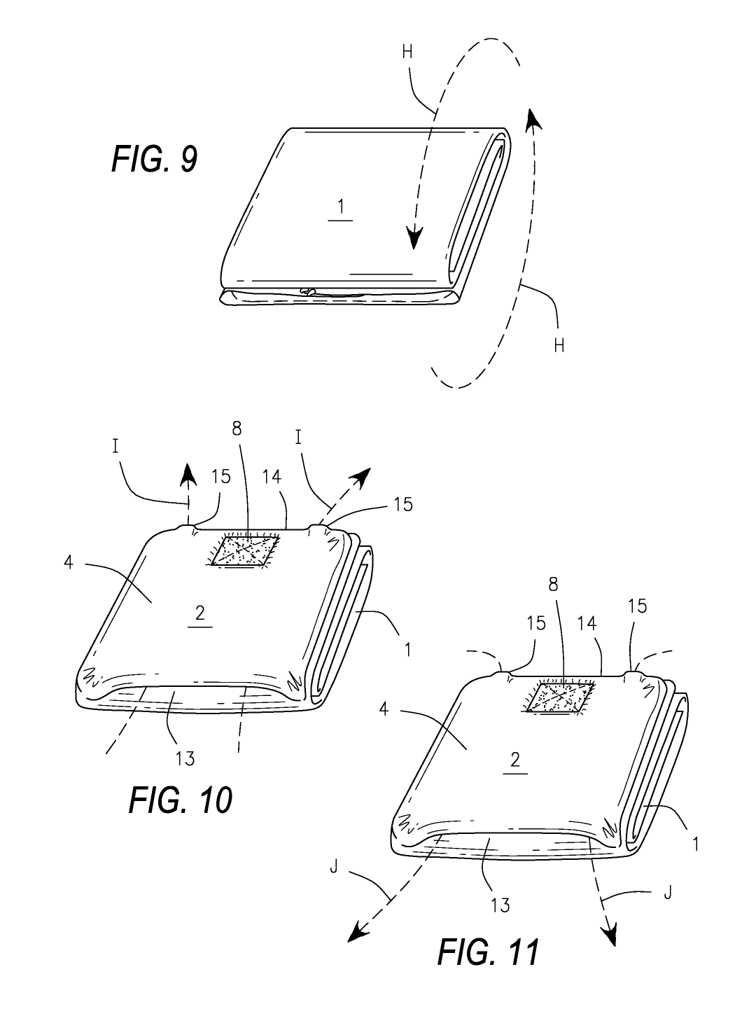

FIGS. 3 through 14 demonstrate folding the combination pillow, blanket, and stuffed toy from a blanket configuration to a pillow configuration and then to a stuffed toy configuration. In FIG. 3, the blanket 1 is fully extended with the pocket 2 located on top of the blanket 1 and the head 5 attached to the pocket 2. As shown in FIG. 4, the head 5 may be removed as indicated by arrow A and the blanket 1 may be turned over as indicated by arrows B. FIG. 5 shows the back of the blanket 1, with the location of the pocket 2 on the inverse side indicated with dashed lines. Next, as indicated in FIG. 6, the blanket may be folded lengthwise in thirds, such that the left section 16, whose former position is indicated in dashed lines, is folded over the middle section 17, as indicated by arrow C, and the right section 18 may be folded over the middle section 17, as indicated by arrow D, resulting in the blanket 1 configured as shown in FIG. 7. As seen in FIG. 8, the blanket 1 may be then folded three times, starting from the end furthest the end with the pocket 2. The first fourth 19 may be folded over the second fourth 20, as indicated by arrow E. They may be then folded over the third fourth 21, as indicated by arrow F. Finally, they may be folded over the fourth fourth 22, as indicated by arrow G. This results in the configuration shown in FIG. 9, wherein the blanket 1 is folded atop the pocket 2. The blanket 1 may be then turned over, as indicated by arrows H, such that the pocket 2 is located atop the folded blanket 1, as shown in FIG. 10. In this configuration, the second side 4 is the outside of the pocket 2 and the first side 3 is the inside of the pocket 2.

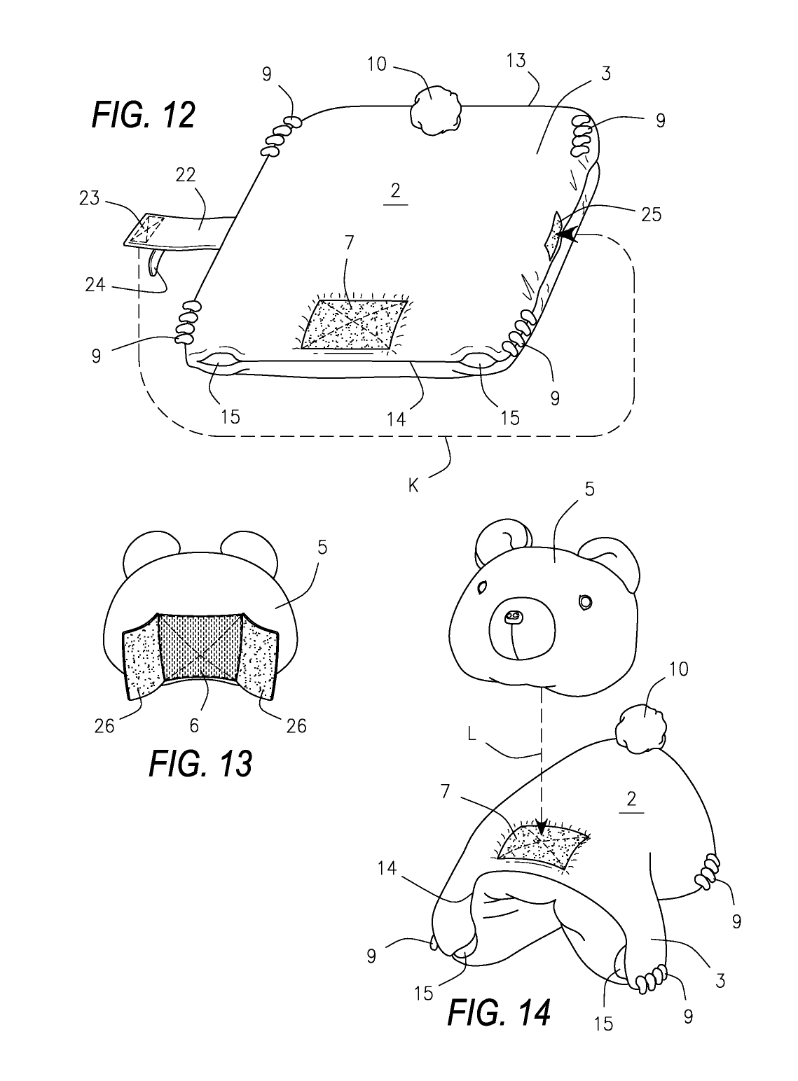

To store the blanket 1 within the pocket 2, the pocket 2 is turned inside out. This may be accomplished by the user placing his or her hands inside the pocket 2 and reaching his or her fingers through the finger holes 15, as indicated by arrows I on FIG. 10. The user may then grasp the layers of blanket 1 adjacent the finger holes 15 and turn the pocket 2 inside out, as indicted by arrows J in FIG. 11. This may be accomplished by quickly snapping the combination pillow, blanket, and stuffed toy while grasping the blanket 1 through the finger holes 15, resulting in the pocket 2 turning inside out with the blanket 1 folded therein, as shown in FIG. 12. This is the pillow configuration, and the user may attach the head 5 for use in the pillow configuration, as shown in FIG. 2, or proceed to the stuffed toy configuration.

The combination pillow, blanket, and stuffed toy may have a strap 22 attached to one side thereof on the first side 3 of the pocket 2, as shown in FIG. 12. The strap 22 may have a patch of hook material 23 on its end opposite the end attached to the pocket 2. The strap 22 may also have a flap 24 for covering the hook material 23 when not in use to prevent injury or irritation to the user. The side of the combination pillow, blanket, and stuffed toy opposite the side with the strap 22 may have a patch of loop material 25. To convert from the pillow configuration to the stuffed toy configuration, the user may extend the strap 22 underneath the combination pillow, blanket, and stuffed toy and attach the hook material 23 to the loop material 25, as indicated by arrow K. This may cause the combination pillow, blanket, and stuffed toy to fold in half downward with a pinched middle, causing the four corners of the pocket 2 to appear to be feet, with the remainder appearing as a body, as shown in FIG. 14. The head 5 may then be attached to the body, as indicated by arrow L, if it is not already attached, thus forming a stuffed toy.

The head 5 may have one or more flaps 26, as shown in FIG. 13, for covering the hook material 6 when the head 5 is not in use on the combination pillow, blanket, and stuffed toy. This allows the head 5 to be used as a separate toy or pillow, as desired.

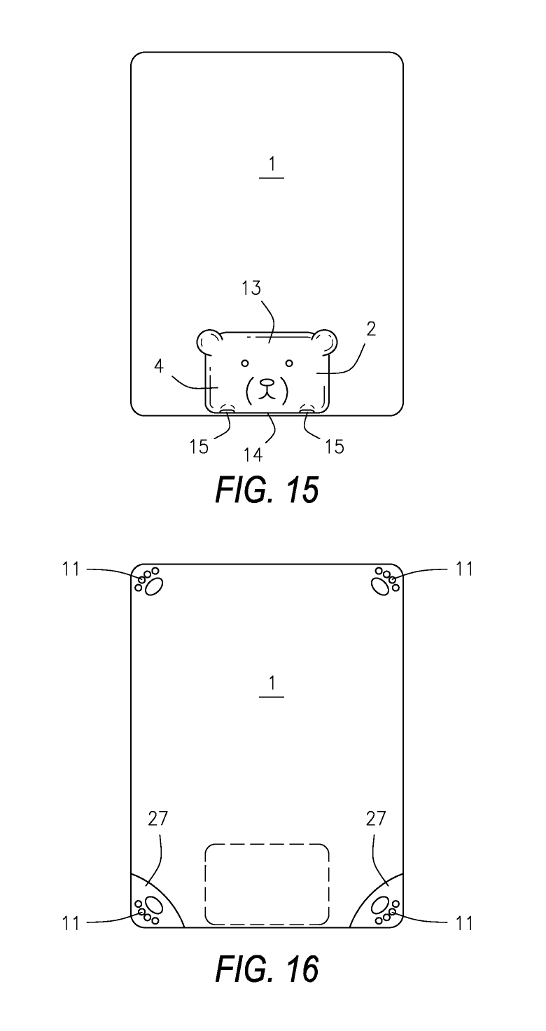

Alternately, head 5 may not be removable. The head 5 may be attached to the first side 3 of the pocket 2, such that it is visible when the combination pillow, blanket, and stuffed toy is in the stuffed toy or pillow configuration, but is located within the pocket 2 when in the blanket configuration. In this embodiment, the second side 4 of the pocket 2 may be shaped and decorated like a head, as shown in FIG. 15.

One or more pockets 27 may be located at the corners of the blanket 1, into which the user may place his or her hands during use.

Unfolding the combination pillow, blanket, and stuffed toy from the stuffed toy configuration to the pillow configuration may be accomplished by detaching the strap 22, allowing the combination pillow, blanket, and stuffed toy to flatten into the pillow configuration. Unfolding the combination pillow, blanket, and stuffed toy from the pillow configuration to the blanket configuration may be accomplished by inverting the pocket 2 so that the blanket 1 is outside the pocket 2. Inverting the pocket 2 may be accomplished by the user inserting his or her hands into the pocket 2 and grasping the blanket 1 through the finger holes 15, and quickly snapping the combination pillow, blanket, and stuffed toy, then unfolding the blanket 1 now located outside the pocket 2.

Whereas, the devices and methods have been described in relation to the drawings and claims, it should be understood that other and further modifications, apart from those shown or suggested herein, may be made within the spirit and scope of this invention.

What is claimed is:

1. A combination pillow, blanket, and stuffed toy comprising:
a blanket with a first end and a second end opposite the first end, where the first end has an edge; and
a pocket attached to the blanket adjacent the first end, where the pocket has an open edge and an edge opposite the open edge, where the edge opposite the open edge is adjacent the edge of the first end, such that the blanket may be folded and the pocket may be turned inside out such that the folded blanket is located inside the pocket.

2. The combination pillow, blanket, and stuffed toy of claim 1 where the pocket has a first edge and a second edge opposite the first edge, where the open edge extends between the first edge and the second edge and the edge opposite the open edge extends between the first edge and the second edge, and where the pocket is connected to the blanket at least along the first edge and the second edge.

3. The combination pillow, blanket, and stuffed toy of claim 1 where the pocket has a first edge and a second edge opposite the first edge, where the open edge extends between the first edge and the second edge and the edge opposite the open edge extends between the first edge and the second edge, the combination pillow, blanket, and stuffed toy further comprising:
a strap with a first end and a second end, where the strap is attached at its first end to the pocket at the first edge of the pocket such that the strap is outside the pocket when the blanket is inside the pocket; and
an attachment device for attaching the second end of the strap to the second edge of the pocket, such that the first edge of the pocket and the second edge of the pocket are held relatively closer to each other such that the pocket enclosing the blanket forms a stuffed toy body.

4. The combination pillow, blanket, and stuffed toy of claim 3 where the attachment device is hook and loop fastener.

5. The combination pillow, blanket, and stuffed toy of claim 4 where the hook and loop fastener comprises:
a patch of hook material on the second end of the strap;
a patch of loop material on the pillow adjacent the second edge; and
a flap attached to the strap adjacent the hook material such that the flap is capable of covering the hook material when not in use.

6. The combination pillow, blanket, and stuffed toy of claim 1 further comprising a stuffed toy head.

7. The combination pillow, blanket, and stuffed toy of claim 6 where:
a patch of hook material is attached to the stuffed toy head;
a patch of loop material corresponding to the patch of hook material on the stuffed toy is attached to the pocket such that the patch is outside the pocket when the blanket is inside the pocket, such that the stuffed toy head may be removably attached to the pocket enclosing the blanket; and
a patch of loop material corresponding to the patch of hook material on the stuffed toy is attached to the pocket such that the patch is outside the pocket when the blanket is outside the pocket, such that the stuffed toy head may be removably attached to the pocket to make the blanket appear to have a head.

8. The combination pillow, blanket, and stuffed toy of claim 7, further comprising at least one flap attached to the stuffed toy head adjacent the patch of hook material such that the at least one flap is capable of covering the hook material when not in use.

9. The combination pillow, blanket, and stuffed toy of claim 6 where the stuffed toy head is non-removably attached to the pocket such that the stuffed toy head is outside the pocket when the blanket is inside the pocket.

10. The combination pillow, blanket, and stuffed toy of claim 9 where the pocket has decorations such that the pocket resembles a head, where such decorations are on the outside of the pocket when the blanket is outside the pocket.

11. The combination pillow, blanket, and stuffed toy of claim 1 further comprising one or more feet, paws, claws, hooves, hands, fins, wheels, or tails attached to the pocket such that the feet, paws, claws, hooves, hands, fins, wheels, or tails are outside the pocket when the blanket is inside the pocket.

12. The combination pillow, blanket, and stuffed toy of claim 1 further comprising one or more feet, paws, claws, hooves, hands, fins, wheels, or tails attached to the blanket.

13. The combination pillow, blanket, and stuffed toy of claim 1 where the blanket has at least one corner, the combination pillow, blanket, and stuffed toy further comprising a pocket attached to the at least one corner of the blanket.

14. The combination pillow, blanket, and stuffed toy of claim 1 where the edge opposite the open edge comprises an attached portion and at least one finger hole, where the attached portion is attached to the blanket and were the at least one finger hole is not attached to the blanket.

15. A method of converting a combination pillow, blanket, and stuffed toy from a blanket to a pillow, where the combination pillow, blanket, and stuffed toy comprises a blanket with a first end and a second end opposite the first end, where the first end has an edge; and a pocket attached to the blanket adjacent the first end, where the pocket has an open edge and an edge opposite the open edge, where the edge opposite the open edge is adjacent the edge of the first end, and where the edge opposite the open edge comprises an attached portion and at least one finger hole, where the attached portion is attached to the blanket and where the at least one finger hole is not attached to the blanket, the method comprising:
placing the blanket with the pocket facing downward;
folding the blanket such that the entire blanket is on top of the pocket;
placing a user's hands within the pocket;
grasping the blanket through the at least one finger hole; and
turning the pocket inside out, such that the folded blanket is located inside the pocket.

16. The method of claim 15 further comprising:
extending a strap underneath the pocket, where:
the strap has a first end and a second end;
the pocket has a first edge and a second edge opposite the first edge, such that the open edge extends between the first edge and the second edge and the edge opposite the open edge extends between the first edge and the second edge; and
the strap is attached at its first end to the pocket at the first edge of the pocket such that the strap is outside the pocket when the blanket is inside the pocket; and
attaching the strap to the second edge of the pocket such that the first edge of the pocket and the second edge of the pocket are held relatively closer to each other such that the pocket enclosing the blanket forms a stuffed toy body.

17. The method of claim 16 further comprising attaching a removable stuffed toy head to the pocket.

18. The method of claim 15 where the step of turning the pocket inside out comprises quickly snapping the combination pillow, blanket, and stuffed animal while grasping the blanket through the at least one finger hole.
